(19) United States
(12) Patent Application Publication
(10) Pub. No.: US 2008/0145510 A1
(43) Pub. Date: Jun. 19, 2008

(54) LACTOBACILLUS-FERMENTED FOOD CONTAINING TOFU PUREE

(75) Inventor: Masanori Hattori, Ebina-shi (JP)

Correspondence Address: WOOD, HERRON & EVANS, LLP, 2700 CAREW TOWER, 441 VINE STREET, CINCINNATI, OH, 45202, US

(73) Assignee: MORINAGA MILK INDUSTRY CO., LTD., Tokyo (JP)

(21) Appl. No.: 11/946,091

(22) Filed: Nov. 28, 2007

(30) Foreign Application Priority Data
Dec. 18, 2006 (JP) 2006-340072

(51) Int. Cl. A23L 1/20

(52) U.S. Cl. 426/634

(57) ABSTRACT

A lactobacillus-fermented food is prepared by fermenting raw materials with a lactobacillus, the raw materials comprising a tofu puree in an amount of 70 to 100% by mass with respect to a total mass of the raw materials, the tofu puree comprising particles and having physical and chemical properties of:

(a) viscosity of 20 to 3,000 mPa·s;
(b) dynamic storage modulus of 0.2 to 600 Pa;
(c) dynamic loss modulus of 0.2 to 250 Pa; and
(d an average particle size of the particles of 2 to 15 μm and a 90% particle size thereof of 35 μm or smaller.

### BACKGROUND OF THE INVENTION

1. Field of the Invention

The present invention relates to a lactobacillus-fermented food (food fermented with lactobacillus) containing a tofu puree, the lactobacillus-fermented food being a novel type with a favorable texture (feeling on the tongue) and flavor similar to those of conventional yoghurt.

Priority is claimed on Japanese Patent Application No. 2006-340072, filed Dec. 18, 2006, the content of which is incorporated herein by reference.

2. Description of the Related Art

In accordance with the increase in health consciousness in recent years, soybean products of vegetable origin have attracted attention. Not only tofu and natto, which are traditional Japanese foods, but also soymilk beverages and soybean desserts have been increasingly produced in recent years.

On the other hand, yoghurt made from dairy products (fermented milk) is known as a macrobiotic food, and has attracted attention because its effect on health and its smooth texture meet the needs of modern people.

Accordingly, various trials have been made to develop fermented products containing soybean products, such products satisfying both concepts of soybean products and fermented milk.

However, the texture, flavor, and other characteristics of fermented products containing soybean products significantly depend on the kind and characteristics of the soybean products used as raw materials. For example, in the case of a fermented product produced using soymilk, the occurrence of a grassy-smell, harsh taste, or other unpleasant flavors unique to soymilk, is a matter to be resolved.

For example, the following methods have been disclosed for producing a fermented soymilk by fermenting soymilk with lactobacillus to improve the flavor unique to soybean:

(1) a method for producing a soymilk beverage containing fruit juice (see Patent Document 1 (Japanese Unexamined Patent Application, First Publication No. S61-141840));
(2) a method for producing kefir-like food (see Patent Document 2 (Japanese Unexamined Patent Application, First Publication No. S62-205735));
(3) a method for producing yoghurt-like soymilk (see Patent Document 3 (Japanese Unexamined Patent Application, First Publication No. S63-7743));
(4) a method for producing tofu without using any coagulants (see Patent Document 4 (Japanese Unexamined Patent Application, First Publication No. H2-167044));
(5) a method for improving soymilk in terms of its flavor and color tone (see Patent Document 5 (Japanese Unexamined Patent Application, First Publication No. H6-276979));
(6) a method for producing lactobacillus-fermented soymilk using an enzyme (rennet) (see Patent Document 6 (Japanese Unexamined Patent Application, First Publication No. H8-66161));
(7) a method in which soymilk is mixed with a coagulant and then fermented with lactobacillus (see Patent Document 7 (Japanese Laid-Open Patent Application No. 2000-93083)); and
(8) a method in which soymilk is mixed with a coagulant and a low-strength agar and then fermented with lactobacillus (see Patent Document 8 (Japanese Laid-Open Patent Application No. 2003-284520)).

Moreover, as a method for decreasing the smell unique to soymilk and improving flavor, a method where a bittern (such as magnesium chloride), which is a traditional coagulant, is added to soymilk is known, and a coagulated product (tofu) prepared by such a method is processed to a paste which is utilized for preparing soybean processed food or the like.

As a method for producing a tofu paste or the like, which is utilized for producing soybean processed food or the like, the following methods, for example, have been disclosed:

(9) a method in which tofu is directly processed to a paste using a silent cutter or the like and then the paste is frozen (see Patent Document 9 (Japanese Unexamined Patent Application, First Publication No. H 6-46784));
(10) a method in which soymilk is mixed with a coagulant to obtain a coagulated product and the coagulated product is dehydrated and then processed to a paste using a high-speed cutter or the like (see Patent Document 10 (Japanese Unexamined Patent Application, First Publication No. H 2-86747)); and
(11) a method in which soymilk is mixed with a coagulant to obtain a coagulated product and the coagulated product is processed to a paste using a homogenizer (see Patent Document 11 (Japanese Unexamined Patent Application, First Publication No. S 59-71641)).

However, the methods disclosed in Patent Documents 1 to 6 have matters to be resolved in that the texture of coagulated products obtained by lactobacillus fermentation is non-smooth and heavy and the aftertaste thereof is unpleasant, despite the smell unique to soymilk being decreased or eliminated by fermentation according to the methods.

Also, the texture of the fermented soymilk obtained by the method disclosed in Patent Document 7 is inferior to the smooth texture of yoghurt made from dairy products (fermented milk).

Moreover, the agar used in the method disclosed in Patent Document 8 is classified as a general food additive and the use of such an additive is inappropriate for healthy food.

According to the production methods disclosed in Patent Documents 9 to 11, tofu is processed to a paste directly or after being dehydrated (that is, after soymilk is coagulated), and thereby the obtained tofu paste causes a grainy and unfavorable texture In the case where such a tofu paste is formulated, the resultant lactobacillus-fermented food also has an unfavorable texture.

### SUMMARY OF THE INVENTION

The present invention relates to a lactobacillus-fermented food, prepared by fermenting a raw material with lactobacillus, the raw material including a tofu puree in an amount of 70 to 100% by mass with respect to a total mass of the raw material, and the tofu puree including particles and having physical and chemical properties of:

(a) viscosity of 20 to 3,000 mPa·s;
(b) dynamic storage modulus of 0.2 to 600 Pa;
(c) dynamic loss modulus of 0.2 to 250 Pa; and
(d) an average particle size of the particles of 2 to 15 μm and a 90% particle size thereof of 35 μm or smaller.

### BRIEF DESCRIPTION OF THE DRAWINGS

FIG. 1 is a drawing illustrating an embodiment of a device for manufacturing a tofu puree to be contained in a lactobacillus-fermented food according to the present invention.

### DEFINITION OF SYMBOLS

1. Raw material tank
2. Metering pump
3. Heating member (plate heater)
4. Heat source
5. Temperature controller
6. Holding pipe
7. Coagulant supply member
8. Coagulant tank
9. Metering pump
10. First emulsification dispersion member (MILDER/trademark)
11. Cooling member (plate cooler)
12. Refrigerant supply member
13. Temperature controller
14. Second emulsification dispersion member (homogenizer)

### DETAILED DESCRIPTION OF THE INVENTION

The present invention has been achieved in view of the above-mentioned circumstances, and has as the object thereof to provide a lactobacillus-fermented food (food fermented with lactobacillus) having a favorable texture and flavor similar to those of yoghurt by using a nutrient-rich soybean product.

The inventors of the present invention decided to use a tofu puree as a soybean product instead of soymilk with a grassy-smell and other non-desirable characteristics. Moreover, the inventors found that physical and chemical properties of tofu puree influence the texture, flavor, and other characteristics of the lactobacillus-fermented food. Based on these findings, investigation was further advanced, and thereby the following lactobacillus-fermented food was found.

The lactobacillus-fermented food is prepared by fermenting a raw material with a lactobacillus, the raw material containing a tofu puree in an amount of 70 to 100% by mass, and the tofu puree containing particles and having the following physical and chemical properties of:

(a) viscosity of 20 to 3,000 mPa·s;
(b) dynamic storage modulus of 0.2 to 600 Pa;
(c) dynamic loss modulus of 0.2 to 250 Pa; and
(d) an average particle size of the particles of 2 to 15 μm and a 90% particle size thereof of 35 μm or smaller.

### <Raw Material>

### (Tofu Puree)

The tofu puree used in the present invention has the physical and chemical properties (a) to (d). The term “tofu puree” means a pureed material prepared using soymilk or tofu as the raw material thereof. The tofu puree is preferably prepared by mixing soymilk with a coagulant, heating the mixture to form a coagulated product, and then crushing the coagulated product, as circumstantially described below.

### Physical and Chemical Property (a):

Physical and chemical property (a) refers to a condition in which the viscosity is within the range of 20 to 3,000 mPa·s. When the viscosity of the tofu puree is within this range, the viscosity of the lactobacillus-fermented food is at an appropriate degree, as a result of which the texture thereof is improved.

The viscosity of the tofu puree can be adjusted by controlling as appropriate the solid content of soybeans in soymilk used as a raw material, dispersing and homogenizing conditions for production using a first emulsification dispersion member or a second emulsification dispersion member, heating conditions, kinds or formulation amounts of the coagulant, or the like.

The method for determining the viscosity concerning the property (a) is as follows. After each sample is left still for 24 hours at 10° C., the viscosity thereof is measured using a B-type viscometer (manufactured by TOKIMEC INC., under the trade name of DVL-BII) equipped with a No. 2, No. 3, or No. 4 rotor at a rotation speed of 60 rpm.

### Physical and Chemical Property (b):

Physical and chemical property (b) refers to a condition in which a dynamic storage modulus is within the range of 0.2 to 600 Pa. When the dynamic storage modulus of the tofu puree is within this range, the dynamic viscoelasticity of the lactobacillus-fermented food is at an appropriate degree, as a result of which the texture thereof is improved.

The dynamic storage modulus of the tofu puree can be adjusted by controlling as appropriate the solid content of soybeans in soymilk used as a raw material, dispersing and homogenizing conditions, or heating conditions, at the time of preparation, kinds or formulation amounts of the coagulant, or the like.

The method for determining the dynamic storage modulus concerning the property (b) is as follows. After each sample is left still for 24 hours at 10° C., the dynamic storage modulus thereof is measured using a viscoelasticity measurement apparatus (manufactured by Rheometric Scientific F.E. Ltd., under the trade name of ARES-200FRT) at a frequency of 50 rad/s at 10° C.

### Physical and Chemical Property (c):

Physical and chemical property (c) refers to a condition in which a dynamic loss modulus is within the range of 0.2 to 250 Pa. When the dynamic loss modulus of the tofu puree is within this range, the dynamic viscoelasticity of the lactobacillus-fermented food is at an appropriate degree, as a result of which the texture thereof is improved.

The dynamic loss modulus of the tofu puree can be adjusted by controlling as appropriate the solid content of soybeans in soymilk used as a raw material, dispersing and homogenizing conditions, or heating conditions, at the time of production, kinds or formulation amounts of the coagulant, or the like.

The dynamic loss modulus concerning the property (c) can be determined by the same way as that of the property (b).

### Physical and Chemical Property (d):

Physical and chemical property (d) refers to a condition in which an average particle size of particles contained in the tofu puree is within the range of 2 to 15 μm, and a 90% particle size thereof is 35 μm or smaller. When the average particle size of the tofu puree is within the above-mentioned range, the texture of the lactobacillus-fermented food is improved. Also, when the 90% particle size of the tofu puree is 35 μm or smaller, the texture of the lactobacillus-fermented food is improved. The reason for improving the texture is that the texture is particularly influenced by the content ratio of large particles.

The average particle size refers to a particle size at 50% counted from a smaller size side on a number base in a cumulative particle size distribution. The 90% particle size refers to a particle size at 90% counted from a smaller size side on a number base in a cumulative particle size distribution.

The average particle size of the particles contained in the tofu puree can be adjusted by controlling as appropriate dispersing and homogenizing conditions at the time of production.

The method for determining the average particle size and 90% particle size concerning the property (d) is as follows. After each sample is left still at 10° C. for 24 hours, the average particle size and the 90% particle size thereof are measured using a laser diffraction particle size distribution analyzer (manufactured by Horiba Seisakusyo Co., Ltd., under the trade name of LA-500).

The values defined in the properties (a) to (d) are not always linked to each other. For example, there is a case in which a tofu puree satisfies the property (a), but does not satisfy at least one of the other properties (b) to (d).

According to the present invention, it has been found that each of the viscosity concerning the property (a), the dynamic storage modulus concerning the property (b), the dynamic loss modulus concerning the property (c), and the average particle size and 90% particle size of particles contained in the tofu puree, concerning the property (d), influences the texture of the lactobacillus-fermented food. The tofu puree satisfying all of the properties (a) to (d) can realize an improved texture of the lactobacillus-fermented food. Because the content of the tofu puree also influences the characteristic, the content thereof is also defined in the present invention, as described below.

The content of the tofu puree satisfying the properties (a) to (d) is 70 to 100% by mass, with respect to the total mass of the raw material. When the content of the tofu puree is within the above-mentioned range, the texture of the lactobacillus-fermented food can be maintained in the best condition.

### (Other Components)

Food materials, such as, for example, water, cane sugar, grape sugar, fruit sugar, oligosaccharide, invert sugar, starch syrup, other sugars, apple juice, lemon juice, or other fruit juice, may be suitably used, unless effects of the present invention are affected. Also, dairy products may be combined.

Available food materials are not limited to the above, and any food materials generally used for lactobacillus-fermented foods may be formulated. The food materials are suitably formulated in accordance with the kind of the lactobacillus-fermented food. Also, each content ratio of the food materials is not particularly limited.

The lactobacillus-fermented food according to the present invention may contain any of the food materials.

### <Lactobacillus>

The lactobacillus-fermented food according to the present invention is prepared by fermenting the raw material containing the tofu puree with lactobacillus. The lactobacillus used for fermentation is not particularly limited, provided that it is generally used for preparing yoghurt. For example, the genus Lactobacillus, such as Lactobacillus delbruekii subsp. bulgaricus, Lactobacillus acidophilus, Lactobacillus helveticus, or the like; the genus Streptococcus such as Streptococcus thermophilus, Streptococcus lactis, or the like; the genus Lactococcus such as Lactococcus lactis subsp. lactis, Lactococcus lactis subsp. cremoris, or the like; the genus Bifidobacterium such as Bifidobacterium bifidum, Bifidobacterium longum, or the like, or other known lactobacillus strains may be used. These lactobacillus strains may be used alone or in combination of at least two kinds thereof.

Such a lactobacillus strain to be formulated for fermentation may be cultivated in a culture medium to a concentration of 10⁸ to 10⁹ CFU/g.

### <Method for Producing Lactobacillus-Fermented Food>

The lactobacillus-fermented food according to the present invention may be produced as follows.

### (Preparation of Tofu Puree)

Preferably, the tofu puree may be prepared by the following steps:

### (A) adding a coagulant to soymilk, and holding the mixture at a temperature between 40° C. and 90° C. to obtain a coagulated product (hereinafter, referred to as Step (A));

### (B) pre-crushing the coagulated product using a first emulsification dispersion member, and then cooling it at a temperature between 10° C. and 35° C. to obtain a pre-crushed material (hereinafter, referred to as Step (B)); and

### (C) crushing the pre-crushed material using a second emulsification dispersion member to particles having an average particle size of 2 to 15 μm and a 90% particle size of 35 μm or smaller (hereinafter, referred to as Step (C)).

In the following, each step will be explained in more detail.

### Step (A):

First, a coagulant is added to soymilk to obtain a mixture, and the mixture is held at a temperature between 40° C. and 90° C. to obtain a coagulated product. As the soymilk used as a staring raw material, any soymilk prepared in accordance with conventional methods may be used, and specific examples thereof include soymilk prepared by soaking soybeans in water for 12 hours, grinding the soaked soybeans using a grinder while adding water thereto to obtain a mash, cooking the mash, and removing soy lees using a separator.

If needed, a soy protein such as an isolated soy protein (manufactured by FUJI OIL CO., LTD., under the trademark of NEW FUJIPRO SEH) or the like may be arbitrarily added to the soymilk.

In particular, it becomes easy to satisfy the properties (a) to (d) by adjusting the solid content of soybeans in the soymilk as a starting raw material within the range of 5 to 15% by mass in this step.

As the coagulant, any substances may be used, provided that they are permitted to be formulated in food and have a capability of coagulating the soymilk. Among them, it is preferable that at least one selected from the group consisting of glucono delta-lactone, calcium acetate, calcium gluconate, calcium lactate, calcium sulfate, calcium chloride, and magnesium chloride be used, because immediate coagulation of the soymilk and prevention of an unpleasant flavor can be realized.

The formulation amount of the coagulant is not particularly limited, provided that coagulation of the soymilk can be realized. In order to satisfy the properties (a) to (d), the formulation amount of the coagulant is preferably within the range of 1% by mass to 7% by mass, with respect to the solid content of soybeans in the soymilk.

The soymilk and the coagulant are mixed uniformly so as to homogeneously react these. In the case of a batch process, the soymilk and the coagulant are preferably agitated using any of various agitators. In the case of a continuous process, the soymilk and the coagulant are preferably mixed uniformly by setting the in-line flow rate of the soymilk at 20 ml/second or higher and the addition rate of the coagulant at 0.2 ml/second or higher.

In order to satisfy the properties (a) to (d), the coagulated product is formed by holding the mixture of the coagulant and the soymilk at a temperature between 40° C. and 90° C.

Although the holding time depends on the solid content of soybeans in the soymilk as a raw material, and the kind and formulation amount of the coagulant, the holding time is preferably 2 to 60 seconds, and more preferably 2 to 20 seconds.

For example, in the case of the in-line process, the coagulated product can be formed by heating the soymilk preferably at a temperature between 40° C. and 90° C. using a plate heater (such as one manufactured by Morinaga Engineering Co., Ltd., or the like) and flowing the mixture of the soymilk and the coagulant at a constant flux (flow rate) through a holding pipe preferably capable of achieving a holding time of 2 to 60 seconds.

### Step (B):

The coagulated product prepared in Step (A) is pre-crushed using the first emulsification dispersion member, and then the pre-crushed material is cooled at a temperature between 10° C. and 35° C.

Although the first emulsification dispersion member is not particularly limited provided that it can pre-crush the coagulated product, an in-line device, more preferably a shear pump (such as, for example, one manufactured by Yasuda Finete) or MILDER (trademark, manufactured by Ebara corporation, for example), is preferably used in view of continuous productivity.

By using such a device, the coagulated product is preferably pre-crushed to particles having an average particle size of 10 to 50 μm. Specifically, when MILDER (trademark) is used, the coagulated product can be pre-crushed to particles having an average particle size of 10 to 50 μm by suitably controlling the rotating speed of MILDER (trademark) within the range of 3,000 rpm to 15,000 rpm.

Next, the pre-crushed material is cooled at a temperature between 10 and 35° C. In the case of using an in-line device, this cooling can be realized by flowing the pre-crushed material through a plate cooler (such as one manufactured by Morinaga Engineering Co., Ltd., or the like). When the temperature is 35° C. or lower, a favorable tofu puree satisfying the properties (a) to (d) can be produced even if overheating occurs as a result of frictional heat in the subsequent crushing step. When the temperature is 10° C. or higher, the pre-crushed material is sufficiently crushed while preventing an increase of the viscosity thereof, and thereby sufficiently dispersed in the following step using the second emulsification dispersion member.

### Step (C):

The tofu puree satisfying the properties (a) to (d) is produced by crushing the pre-crushed material prepared in Step (B) to particles having an average particle size of 2 to 15 μm and a 90% particle size of 35 μm or smaller using the second emulsification dispersion member.

The second emulsification dispersion member is not particularly limited provided that it can crush particles contained in the pre-crushed material to particles having the defined particle sizes. In view of continuous productivity, an in-line device, more preferably a homogenizer (such as one manufactured by Sanmaru Machinery Co., Ltd., or the like), shear pump (such as one manufactured by Yasuda Finete, or the like), or MILDER (trademark, manufactured by Ebara corporation), is preferably used.

Specifically, when the homogenizer is used for crushing, the crushed material satisfying the above-defined properties can be obtained by suitably controlling the treatment pressure within the range between 2 and 150 MPa, and more preferably between 2 and 17 MPa. In this case, it is favorable that crushing be performed while cooling so that the treatment temperature be held at a constant temperature or lower, for example, 25° C., and thereby, the tofu puree can be prevented from being heated by the frictional heat.

### (Production of Soymilk Puree Using an In-Line Device)

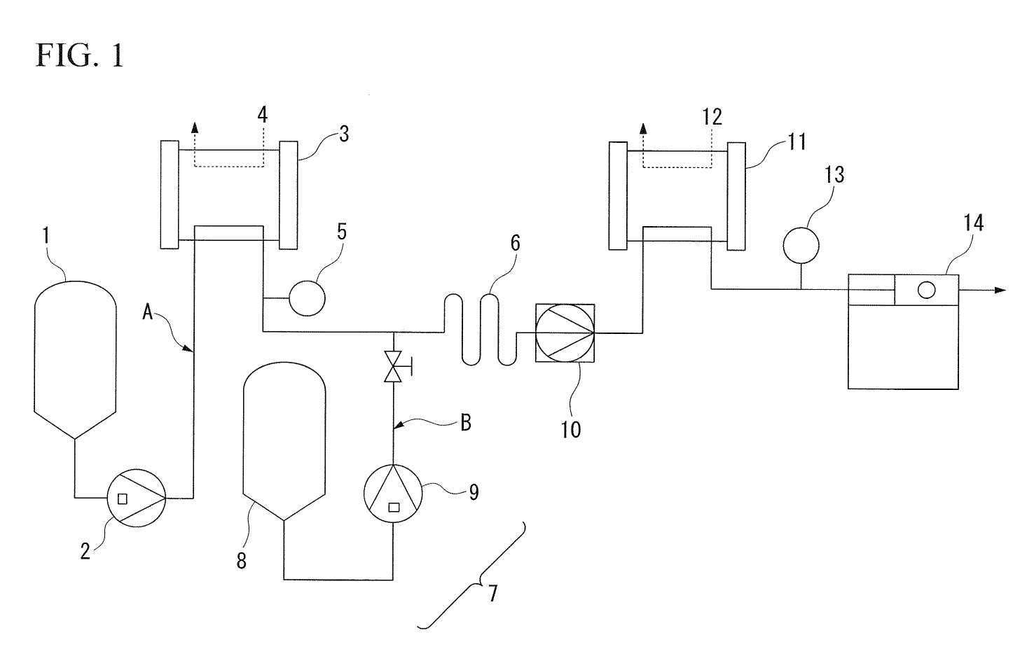

It is preferable that the above-mentioned steps (A) to (C) be carried out using an in-line device as illustrated in FIG. 1, for example.

As shown in FIG. 1, the device for producing the tofu puree is schematically composed of a system in which a raw material tank 1, a heating member 3, a holding pipe 6, a first emulsification dispersion member 10, a cooling member 11, and a second emulsification dispersion member 14 are connected in this order through a line A, and a coagulant supply member 7 that supplies a coagulant, the coagulant supply member 7 being linked via a line B to the line A at a position between the heating member 3 and the holding pipe 6.

The raw material tank 1 may be any type of tank, provided that it can hold soymilk and is sanitary for food handling.

On the line A, a metering pump 2 equipped with a flux regulator valve is disposed downstream from the raw material tank 1, and the heating member 3 is disposed downstream from the metering pump 2.

The heating member 3 is equipped with a heat source 4 and is an apparatus that heats a liquid. Examples of the heating member 3 include a plate heater, a tubular heater, and other heat exchangers. Examples of the heat source 4 include steam, hot water, and the like.

At an outlet of the heating member 3, a temperature controller 5 that automatically controls the temperature of the liquid at the outlet is disposed. The heating member 3 need not be a single apparatus, and may be composed of plural heat exchangers to perform heating in stages.

The holding pipe 6 is disposed downstream from the temperature controller 5. The holding pipe 6 holds the mixture of the soymilk and the coagulant for a specific time at a constant temperature to form the coagulated product.

The line B extending from the coagulant supply member 7 that supplies the coagulant is linked to the line A at a position between the heating member 3 and the holding pipe 6.

The coagulant supply member 7 involves a coagulant tank 8 and a metering pump 9 equipped with a flux regulator valve, and is capable of supplying the coagulant in specific amounts to the soymilk that has been heated at a temperature between 40° C. and 90° C. using the heating member.

The first emulsification dispersion member 10 is disposed downstream from the holding pipe 6 in the line A. The first emulsification dispersion member 10 is not particularly limited provided that it can pre-crush the coagulated product, and examples thereof include a shear pump and MILDER (trademark).

The cooling member 11 is disposed downstream from the first emulsification dispersion member 10 in the line A. The cooling member 11 is equipped with a refrigerant supply member 12 and is an apparatus that cools a liquid. Examples of the cooling member 11 include a plate cooler, a tubular heater, and other heat exchangers. Examples of refrigerant used in the refrigerant supply member 12 include water, chilled water, and the like.

In the vicinity of an outlet of the cooling member 11 on the line A, a temperature controller 13 that automatically controls the temperature of a liquid at the outlet of the cooling member II is disposed. The cooling member 11 need not be a single apparatus, and may be composed of plural heat exchangers to cool in stages.

The second emulsification dispersion member 14 is disposed downstream from the cooling member 11. The second emulsification dispersion member 14 is not particularly limited provided that it can crush the pre-crushed material to particles having a specific average particle diameter and a specific 90% particle diameter, and examples thereof include a homogenizer, a shear pump, and MILDER (trademark).

It is preferable that each component of the device be sterilely sealed and the production be carried out under sterile conditions, because a large amount of products free from microbial contamination can be manufactured.

Although pipes and apparatuses that serve to sterilize the pipe line of the device before producing the tofu puree are disposed in the device, the pipes and the apparatuses are not shown in FIG. 1. Also, although pipes and apparatuses that serve to wash the pipe line of the device after producing the tofu puree are disposed in the device, the pipes and the apparatuses are not shown in FIG. 1. Also, although pressure gages that enable the pressure inside the pipe line of the device to be visually checked, thermometers that enable the liquid temperature inside the pipe line to be visually checked, and automatic controllers that automatically control the pressure and the temperature in various places, are disposed in the device, the pressure gages, thermometers, and the automatic controllers are not shown in FIG. 1.

Moreover, although each of the heating member 3, first emulsification dispersion member 10, cooling member 12, and second emulsification dispersion member 15, is equipped with a pipe that serves to return the liquid from the outlet to inlet thereof if each treatment is not sufficiently performed, the pipe is not shown in FIG. 1. Also, although a mixer that uniformly mixes the starting soymilk, a by-pass pipe to be used at the time of emergency or periodic maintenance, and pipes and apparatuses that serve to control the quantity of flow in the pipe line, such as a flux regulator valve, are disposed in the device, they are not shown in FIG. 1.

In the following, the method for producing the tofu puree using the device will be explained.

First, soymilk is put into the raw material tank 1. Next, the soymilk is supplied to the heating member 3 by operating the metering pump 2, and the soymilk is heated by operating the heat source 4. The heating temperature of the soymilk is controlled using the temperature controller 5.

Then, the heated soymilk is supplied to the holding pipe 6.

On the other hand, a coagulant is put into the coagulant tank 8. Then, the coagulant is supplied from the line B to the line A linked therewith at the position between the heating member 3 and the holding pipe 6 by operating the metering pump 9. Thus, the soymilk and the coagulant are mixed together at an upstream portion from the holding pipe 6, and the mixture is held at a predetermined temperature inside the holding pipe 6, as a result of which a coagulated product is formed (see the above-mentioned Step (A)).

Next, this coagulated product is supplied to the first emulsification dispersion member 10, pre-crushed, supplied to the cooling member 11, and then cooled by operating the refrigerant supply member 12, to obtain a pre-crushed material. The cooling temperature is controlled using the temperature controller 13 disposed downstream from the refrigerant supply member 12 (see the above-mentioned Step (B)).

Next, this pre-crushed material is supplied to the second emulsification dispersion member 14 and crushed to particles satisfying the defined properties, and thus the tofu puree is produced (see the above-mentioned Step (C)).

### (Production of Lactobacillus-Fermented Food)

The lactobacillus-fermented food can be produced using the tofu puree produced by the above-mentioned method. In the following, one typical method for producing the lactobacillus-fermented food will be explained.

A raw material is prepared by adding water and food materials, as needed, to 70 to 100% by mass of the tofu puree with respect to the total mass of the raw material. A lactobacillus is added to the raw material, and then fermented by heating the mixture at 30° C. to 40° C. until pH of the mixture reaches 4.4 to 4.8. Immediately after the fermentation, the resultant is cooled at 10° C. to obtain a lactobacillus-fermented food.

The amount of the lactobacillus to be added is preferably within the range of 0.5 to 3.0 parts by mass with respect to 100 parts by mass of the tofu puree.

The complex viscosity, dynamic storage modulus, and dynamic loss modulus of the lactobacillus-fermented food obtained by such a way are approximate to those of commercially available fermented milk, such as yoghurt, the complex viscosity, dynamic storage modulus, and dynamic loss modulus being indexes of texture and flavor. Thus, the lactobacillus-fermented food has a favorable texture and flavor similar to those of conventional yoghurt or the like.

The complex viscosity of the lactobacillus-fermented food is preferably within the range of 0.30 to 1.35 Pa. The dynamic storage modulus of the lactobacillus-fermented food is preferably within the range of 11.8 to 36.6 Pa. The dynamic loss modulus is preferably within the range of 9.0 to 20.5 Pa.

The lactobacillus-fermented food according to the present invention is a novel type one in that an excellent texture and flavor, which are not achieved by conventional products, are provided.

As is apparent from examples described below, a tofu paste prepared by directly processing the tofu as described above to a paste, or a tofu paste prepared by dehydrating a coagulated product of a mixture composed of soymilk and a coagulant followed by processing the resultant to a paste, has physical and chemical properties exceeding the upper limits of the above-mentioned physical and chemical properties (a) to (d). Moreover, such a tofu paste has a grainy and unfavorable texture. Also, a lactobacillus-fermented food prepared by formulating such a tofu paste followed by subjecting to lactate fermentation has unfavorable texture.

Also, a tofu paste prepared by adding a coagulant to soymilk without homogenizing, or a tofu paste prepared by homogenizing using a homogenizer only, has an average particle size exceeding 15 μm and a 90% particle size exceeding 35 μm. Accordingly, a lactobacillus-fermented food prepared by formulating such a tofu paste followed by subjecting to lactate fermentation has also unfavorable texture.

Although fermented soymilk generally has a decreased smell unique to soybeans, the texture of the coagulated soymilk produced by lactate fermentation is nonsmooth and heavy, and the flavor thereof is unfavorable.

On the other hand, the lactobacillus-fermented food according to the present invention overcomes such problems of conventional lactobacillus-fermented foods prepared using soybean products.

### EXAMPLES

Hereinafter, the lactobacillus-fermented food according to the present invention will be explained in more detail with reference to examples. However, it is apparent that the present invention is not limited to these examples. Also, “%” and “part(s)” used in the examples indicates “% by mass” and “part(s) by mass”, respectively, unless otherwise so indicated.

### <Evaluation>

### 1. Measurement of properties, concerning the properties (a) to (d), of tofu puree.

Measurement of the properties, concerning the properties (a) to (d), of tofu puree were performed as described above.

### 2. Evaluation of characteristics of lactobacillus-fermented food.

### (1) Measurement of the complex viscosity, dynamic storage modulus, and dynamic loss modulus.

Each sample was left still for 24 hours at 10° C., and the complex viscosity, dynamic storage modulus, and dynamic loss modulus thereof were measured using a dynamic viscoelasticity measurement apparatus (manufactured by Rheometric Scientific F.E. Ltd., under the trade name of ARES viscoelasticity measurement system) at a frequency of 50 rad/s at 10° C.

### (2) Evaluation of Texture

Each sample was subjected to a sensory test by a panel composed of 20 men and women, ages 20 to 40. Each sample was evaluated by each panelist in accordance with the following criteria.

| | |
|---|---|
| 0 points: | Favorable texture. |
| 1 point: | Slightly favorable texture. |
| 2 points: | Slightly unfavorable texture. |
| 3 points: | Unfavorable texture. |

The scores for each sample were averaged, and the averaged value was evaluated in accordance with the following criteria.

| | |
|---|---|
| Favorable: | Less than 0.5 points. |
| Slightly favorable: | At least 0.5 points, but less than 1.5 points. |
| Slightly unfavorable: | At least 1.5 points, but less than 2.5 points. |
| Unfavorable: | At least 2.5 points, but less than 3.0 points. |

### (3) Evaluation of Flavor

Each sample was subjected to a sensory test by a panel composed of 20 men and women, ages 20 to 40. Each sample was evaluated by each panelist in accordance with the following criteria.

| | |
|---|---|
| 0 points: | Favorable flavor. |
| 1 point: | Slightly favorable flavor. |
| 2 points: | Slightly unfavorable flavor. |
| 3 points: | Unfavorable flavor. |

The scores for each sample were averaged, and the averaged value was evaluated in accordance with the following criteria.

| | |
|---|---|
| Favorable: | Less than 0.5 points. |
| Slightly favorable: | At least 0.5 points, but less than 1.5 points. |
| Slightly unfavorable: | At least 1.5 points, but less than 2.5 points. |
| Unfavorable: | At least 2.5 points, but less than 3.0 points. |

### <Production of Soymilk>

### Reference Example 1

60 kg of US soybeans (GL 2930 imported by HONDA TRADING CORPORATION) were washed and then were allowed to swell by being soaked in flowing water for 12 hours. The swollen soybeans were supplied together with 170 kg of water to a grinder (manufactured by Nagasawa Kikai Seisakusho Co., Ltd.) and ground so that approximately 220 kg of soybean slurry was obtained. Approximately 220 kg of this soybean slurry was cooked for 4 minutes at 100° C. using a continuous cooking kettle (manufactured by Nagasawa Kikai Seisakusho Co., Ltd.), and separated into soymilk and soy lees using a filter screw press (manufactured by Arai machinery corporation) so that approximately 190 kg of soymilk was obtained. The soybean-solid content of the obtained soymilk was approximately 13%.

### Reference Example 2

10 parts of water were added to 1 part of soybeans subjected to dehull and hypocotyl-removing treatment, and then left still at 30 to 50° C. for 60 minutes so that the soybeans were allowed to swell by sufficiently absorbing water. 1 part of the swollen soybeans (with a moisture content of 40 to 55%) was supplied together with 3 parts of hot water (90° C.) to a grinder (manufactured by MASUKO SANGYO CO., LTD.) and ground. Then, a sodium hydrogen carbonate solution was added to the resultant so that pH thereof was 7.4 or higher and 8.0 or lower The resultant was supplied to a homogenizer (manufactured by APC (Invensys Systems, Inc.)) and homogenized at a pressure of 170 kg/cm². The homogenized soybean slurry was separated into soymilk and soy lees by centrifuging at 3,000 G for 5 minutes. The solid content of the soymilk was 9.0%.

### Test Example 1

### Comparison with Prior Art

Test example 1 was carried out to demonstrate that lactobacillus-fermented foods according to the present invention exhibited characteristics superior to those of comparative examples obtained in accordance with prior arts.

Samples (lactobacillus-fermented foods) were prepared in the following examples and comparative examples, and then evaluated, as follows. Evaluation results of the samples are shown in Table 1.

### Example 1-1

### (1) Preparation of Tofu Puree

A tofu puree was prepared using the tofu puree manufacturing device shown in FIG. 1.

100 kg of soymilk prepared by the same method as in Reference Example 1 to have a solid content of 13%, the soymilk being held at 10° C. in the raw material tank 1, was pumped to the heating member 3 using the metering pump 2 equipped with a flux regulator valve (manufactured by NAKAKIN CO., LTD.). The soymilk that flowed into the heating member 3 was heated at 60° C. by hot water of the heat source 4 of which the temperature was controlled by the temperature controller 5 (manufactured by Yokokawa Electric Corporation), and pumped toward the holding pipe 6 at 28 ml/second.

On the other hand, a coagulant (magnesium chloride manufactured by Nichia Chemical Industries) held in the coagulant tank 8 (manufactured by Morinaga Engineering Co., Ltd.) of the coagulant supply member 7 was supplied at 0.4 ml/second to the soymilk pumped from the heating member 3 using the metering pump 9 equipped with the flux regulator valve (manufactured by FMI Corporation) so that the coagulant was supplied in an amount of 4% with respect to the solid content of the soymilk, and the coagulant and soymilk were uniformly mixed together. The mixture was held for 3 seconds at 60° C. in the holding pipe 6 to produce coagulated soymilk, and the coagulated soymilk was transferred to the first emulsification dispersion member 10 (manufactured by Ebara Seisakusyo Co., Ltd. under the trademark of MILDER).

Next, the coagulated soymilk transferred to the first emulsification dispersion member 10 was immediately pre-crushed to particles having an average particle size of 20 μm using MILDER (trademark) at a rotation speed of 12,000 rpm, and then transferred to the cooling member 11. The pre-crushed product transferred to the cooling member 11 was cooled by cold water (refrigerant 12) kept at 30° C. by the temperature controller 13 (manufactured by Yokokawa Electric Corporation), and transferred to the second emulsification dispersion member 14 (homogenizer, manufactured by Sanmaru Machinery Co. Ltd.). The pre-crushed material transferred to the second emulsification dispersion member 14 was crushed at a treatment pressure of 12 MPa to have particles having an average particle size of 13.4 μm and a 90% particle size of 23.1 μm. The thus obtained tofu puree had a viscosity of 1,100 mPa·s, a dynamic storage modulus of 14.5 Pa, and a dynamic loss modulus of 8.7 Pa.

### (2) Preparation of Lactobacillus-Fermented Food Containing Tofu Puree

A raw material was prepared by mixing 80 kg of the tofu puree obtained above with 19.4 kg of dissolution water. To the raw material, 0.3 kg cultivated liquids of each lactobacillus of Lactobacillus delbruekii subsp. bulgaricus (available from Chr. Hansen, Denmark) and Streptococcus thermophilus (available from Chr. Hansen, Denmark), were added, and then fermented by leaving the mixture still at 40° C. for 6 to 8 hours until pH thereof reached 4.6 to 4.8. Then, the resultant was cooled and held at 10° C. for 24 hours.

### Example 1-2

### (1) Preparation of Tofu Puree

A tofu puree was prepared using the tofu puree manufacturing device shown in FIG. 1 in a similar manner to that of Example 1-1, except that some of the manufacturing conditions were changed, as follows.

(i) The heating temperature of the heating member 3 was changed to 80° C.
(ii) The holding temperature of the holding pipe 6 was changed to 80° C.
(iii) The average particle size of particles pre-crushed using MILDER (trademark) was 10 μm.
(iv) The treatment pressure of the homogenizer was changed to 3 MPa, and the average particle size of crushed particles was 4.8 μm and the 90% particle size thereof was 8.0 μm.

The thus obtained tofu puree had a soybean-solid content of 13%, a viscosity of 233 mPa·s, a dynamic storage modulus of 1.5 Pa, a dynamic loss modulus of 1.1 Pa, and favorable flavor free from grainy texture.

### (2) Preparation of Lactobacillus-Fermented Food Containing Tofu Puree

A raw material was prepared by mixing 70 kg of the tofu puree obtained above with 18.5 kg of dissolution water, followed by dissolving 10 kg of cane sugar therein. To the raw material, 0.5 kg cultivated liquids of each lactobacillus of Lactobacillus delbruekii subsp. bulgaricus (available from Chr. Hansen, Denmark), Streptococcus thermophilus (available from Chr. Hansen, Denmark), and Bifidobacterium longum FERM BP-7787, were added, and then fermented by leaving the mixture still at 40° C. for 5 to 7 hours until pH thereof reached 4.4 to 4.6. Then, the resultant was cooled and held at 10° C. for 24 hours. Bifidobacterium longum (accession number FERM BP-7787) was deposited as an international deposition under the Budapest Treaty on Oct. 31, 2001, with the International Patent Organism Depositary, National Institute of Advanced Industrial Science and Technology, AIST Tsukuba Central 6, 1-1, Higashi 1-Chome Tsukuba-shi, Ibaraki-ken, 305-8566, JAPAN.

### Comparative Example 1-1

A lactobacillus-fermented food was prepared in a similar manner to that of Example 1-1, except that soymilk described below was used instead of the tofu puree.

The soymilk was prepared in accordance with the method disclosed in Patent Document 7 using the soymilk prepared in Reference Example 2. That is, the soymilk prepared in Reference Example 2 was heated at 80° C., and a magnesium chloride aqueous solution was mixed therewith as a coagulant in an amount of 0.2% with respect to the soybean-solid content of the soymilk. Then, the mixture was left still at 80° C. for 5 minutes, and then cooled at 70° C., followed by homogenizing using a homogenizer at 100 kg/cm². The resultant had a viscosity of 460 mPa·s, a dynamic storage modulus of 10.5 Pa, a dynamic loss modulus of 8.9 Pa, an average particle size of 40 μm, and a 90% particle size of 96 μm.

### Comparative Example 1-2

A lactobacillus-fermented food was prepared in a similar manner to that of Example 1-1, except that soymilk described below was used instead of the tofu puree.

The soymilk was prepared in accordance with the method disclosed in Patent Document 8 using the soymilk prepared in Reference Example 2. That is, the soymilk prepared in Reference Example 2 was heated at 60° C., and each aqueous solution or aqueous dispersion of low-strength agar “Ultra Agar UX 100” (manufactured by Ina Food Industry Co., Ltd.) or bittern from a salt farm (manufactured by AKO KASEI CO., LTD.) was mixed therewith in an amount of 1% and 1.6%, respectively, with respect to the soybean-solid content of the soymilk. Then, the mixture was left still at 60° C. for 5 minutes, and then sterilized at 142° C. for 4 seconds by direct instantaneous heating, followed by homogenizing using a homogenizer at 100 kg/cm². The resultant had a viscosity of 1,600 mPa·s, a dynamic storage modulus of 47.2 Pa, a dynamic loss modulus of 45.9 Pa, an average particle size of 84 μm, and a 90% particle size of 142 μm.

TABLE 1

| | | | | Comparative | Comparative | |
|---|---|---|---|---|---|---|
| | | Example | Example | Example | Example | Commercialized |
| | | 1-1 | 1-2 | 1-1 | 1-2 | product* |
| Lactobacillus- | Texture | Favorable | Favorable | Slightly | Unfavorable | — |
| fermented | | | | unfavorable | | |
| food | Flavor | Favorable | Favorable | Unfavorable | Unfavorable | — |
| | Complex | 0.53 | 0.32 | 0.28 | 1.32 | 0.30-1.35 |
| | viscosity | | | | | |
| | (Pa) | | | | | |
| | Dynamic | 22.0 | 12.2 | 10.5 | 47.2 | 11.8-36.6 |
| | storage | | | | | |
| | modulus | | | | | |
| | (Pa) | | | | | |
| | Dynamic | 12.2 | 9.8 | 8.9 | 45.9 | 9.0-20.5 |
| | loss | | | | | |
| | modulus | | | | | |
| | (Pa) | | | | | |

*Commercialized product: Range of values of 10 kinds of commercially available fermented milk (free from any additives such as sugars, gelatinizing agents, or the like) is indicated.

It is apparent from the results shown in Table 1 that the samples of Examples 1-1 and 1-2 provided superior results in the sensory tests (regarding flavor and texture) to those of Comparative Examples 1-1 and 1-2.

As a result of comparison of the samples with 10 kinds of commercially available fermented milk, it is revealed that the complex viscosity, dynamic storage modulus, and dynamic loss modulus of the samples of Examples 1-1 and 1-2 were at the same level as those of the commercially available fermented milk, that is, the samples of Examples 1-1 and 1-2 exhibited favorable properties similar to those of conventional yoghurt. On the other hand, the complex viscosity, dynamic storage modulus, and dynamic loss modulus of the sample of Comparative Example 1-1 were lower than those of the fermented milk, but those of the sample of Comparative Example 1-2 were higher than those of the fermented milk. In both cases, no favorable properties similar to those of conventional yoghurt were exhibited.

When other tests were carried out in the same way as described above, except that the kind of soymilk was suitably changed, similar results were obtained.

### Test Example 2

### Comparison of Lactobacillus-Fermented Foods Prepared Using Various Tofu Purees with Different Physical and Chemical Properties

Test Example 2 was carried out to examine the influence of the physical and chemical properties (a) to (d) of tofu puree on characteristics of lactobacillus-fermented foods prepared therefrom in Examples 2-1 to 2-3 and Comparative Examples 2-1 and 2-2 described below.

### Examples 2-1 to 2-3 and Comparative Examples 2-1 and 2-2

### Preparation of Samples

Tofu purees each having different physical and chemical properties, that is, viscosity, dynamic storage modulus, dynamic loss elastic modulus, average particle size, and 90% particle size, were prepared by a similar method to that of Example 1-1, except that the treatment pressure of the homogenizer was changed as follows. Each property of the tofu purees concerning physical and chemical properties (a) to (d) is shown in Table 2.

### Comparative Example 2-1

The treatment pressure of the homogenizer was set at 0 MPa.

### Example 2-1

The treatment pressure of the homogenizer was set at 1 MPa.

### Example 2-2

The treatment pressure of the homogenizer was set at 12 MPa.

### Example 2-3

The treatment pressure of the homogenizer was set at 17 MPa.

### Comparative Example 2-2

The treatment pressure of the homogenizer was set at 20 MPa.

Then, in each of Examples 2-1 to 2-3 and Comparative examples 2-1 and 2-2, five samples of lactobacillus-fermented food were prepared in a similar manner to that of Example 1-1, except that the tofu puree prepared above was used instead of the tofu puree of Example 1-1. The samples were evaluated and the results thereof are shown in Table 2.

TABLE 2

| | | Comparative | | | | Comparative |
|---|---|---|---|---|---|---|
| | | Example | Example | Example | Example | Example |
| | | 2-1 | 2-1 | 2-2 | 2-3 | 2-2 |
| Tofu | Viscosity | 10 | 20 | 1,100 | 3,000 | 4,000 |
| puree | (mPa · s) | | | | | |
| | Dynamic | 0.1 | 0.2 | 14.5 | 600.0 | 647.5 |
| | storage | | | | | |
| | modulus | | | | | |
| | (Pa) | | | | | |
| | Dynamic | 0.1 | 0.2 | 8.7 | 250.0 | 258.6 |
| | loss | | | | | |
| | modulus | | | | | |
| | (Pa) | | | | | |
| | Average | 1.0 | 2.0 | 13.4 | 15.0 | 21.2 |
| | particle | | | | | |
| | size | | | | | |
| | (μm) | | | | | |
| | 90% | 10.2 | 15.3 | 23.1 | 35.0 | 38.5 |
| | particle | | | | | |
| | size | | | | | |
| | (μm) | | | | | |
| Lactobacillus- | Texture | Unfavorable | Favorable | Favorable | Favorable | Unfavorable |
| fermented | Flavor | Favorable | Favorable | Favorable | Favorable | Favorable |
| food | Complex | 0.04 | 0.30 | 0.53 | 1.35 | 1.90 |
| | viscosity | | | | | |
| | (Pa) | | | | | |
| | Dynamic | 1.4 | 11.8 | 22.0 | 36.6 | 39.0 |
| | storage | | | | | |
| | modulus | | | | | |
| | (Pa) | | | | | |
| | Dynamic | 1.5 | 9.0 | 12.2 | 20.5 | 21.0 |
| | loss | | | | | |
| | modulus | | | | | |
| | (Pa) | | | | | |

As is apparent from results shown in Table 2, the lactobacillus-fermented foods prepared using the tofu purees with particular physical and chemical properties had a complex viscosity of 0.30 to 1.35 Pa, dynamic storage modulus of 11.8 to 36.6 Pa, and a dynamic loss modulus of 9.0 to 20.5 Pa. Such lactobacillus-fermented foods exhibited favorable texture and flavor.

When other tests were carried out in the same way as described above, except that the kind of soymilk, coagulant, or emulsification dispersion member was suitably changed, similar results were obtained.

### Test Example 3

### Comparison of Lactobacillus-Fermented Foods with Different Contents of Tofu Puree

Test Example 3 was carried out to examine the influence of the contents of the tofu puree on characteristics of lactobacillus-fermented food prepared therefrom in Comparative Example 3-1 and Examples 3-1 to 3-4 described below.

### Comparative Example 3-1 and Examples 3-1 to 3-4

In each of Comparative Example 3-1 and Examples 3-1 to 3-4, five samples of lactobacillus-fermented food were prepared in a similar manner to that of Example 1-1, except that the content of the tofu puree was varied from 60 to 100%, with respect to the total mass of the raw material, as shown in Table 3. The characteristics of the samples were evaluated and results thereof are shown in Table 3.

TABLE 3

| | | Comparative | | | | |
|---|---|---|---|---|---|---|
| | | Example | Example | Example | Example | Example |
| | | 3-1 | 3-1 | 3-2 | 3-3 | 3-4 |
| Content of tofu puree | | 60 | 70 | 80 | 90 | 100 |
| (% by mass) | | | | | | |
| Lactobacillus- | Texture | Unfavorable | Favorable | Favorable | Favorable | Favorable |
| fermented | Flavor | Favorable | Favorable | Favorable | Favorable | Favorable |
| food | Complex | 0.16 | 0.30 | 0.53 | 0.72 | 1.20 |
| | viscosity | | | | | |
| | (Pa) | | | | | |
| | Dynamic | 7.3 | 11.8 | 22.0 | 29.5 | 36.2 |
| | storage | | | | | |
| | modulus | | | | | |
| | (Pa) | | | | | |
| | Dynamic | 3.7 | 9.1 | 12.2 | 17.2 | 20.3 |
| | loss | | | | | |
| | modulus | | | | | |
| | (Pa) | | | | | |

As is apparent from results shown in Table 3, the lactobacillus-fermented foods prepared using the raw material containing at least 70% of the tofu puree with respect to the total mass of the raw material exhibited excellent texture and flavor

When other tests were carried out in the same way as described above, except that the kind of soymilk, coagulant, or emulsification dispersion member was suitably changed, similar results were obtained.

As is apparent from the results of the above-mentioned test examples, the lactobacillus-fermented foods prepared in the examples according to the present invention were novel type ones with excellent texture and flavor which were not realized by the prior arts.

Thus, according to the present invention, the lactobacillus-fermented food with favorable texture and flavor similar to those of yoghurt is provided using the nutrient-rich soybean product.

What is claimed is:

1. A lactobacillus-fermented food, prepared by fermenting a raw material with a lactobacillus, the raw material comprising a tofu puree in an amount of 70 to 100% by mass with respect to a total mass of the raw material, the tofu puree comprising particles and having physical and chemical properties of:
(a) viscosity of 20 to 3,000 mPa·s;
(b) dynamic storage modulus of 0.2 to 600 Pa;
(c) dynamic loss modulus of 0.2 to 250 Pa; and
(d) an average particle size of the particles of 2 to 15 μm and a 90% particle size thereof of 35 μm or smaller.
